(19) United States
(12) Patent Application Publication
(10) Pub. No.: US 2007/0276636 A1
(43) Pub. Date: Nov. 29, 2007

(54) System for visualization and analysis of numerical and chemical information

(76) Inventor: Barry John Wythoff, Newburyport, MA (US)

Correspondence Address: BARRY WYTHOFF, ONE MARKET SQUARE, UNIT 2, NEWBURY PORT, MA, 01950, US

(21) Appl. No.: 11/167,631

(22) Filed: Jun. 26, 2005

Related U.S. Application Data
(60) Provisional application No. 60/583,180, filed on Jun. 26, 2004.

(51) Int. Cl. G06F 17/10; G06N 5/02

(52) U.S. Cl. 703/2; 706/48; 715/506

(57) ABSTRACT

The invention contains methods for identifying, parameterizing, saving and utilizing Multicriterion Decision Making (MCDM) functions to analyze data sets. The invention contains methods for performing selections with individual interaction with checkboxes, plots, algorithms, and queries, all linked to a single selection state attribute that is automatically added to each dataset. Successive selection steps may be combined with boolean operators: SET/AND/OR. Selection state is sortable to allow selected objects to be visually collected. Together, this provides a powerful suite for MCDM, which is true Decision Support. The invention contains methods for visualizing molecular structures which allow greater cognitive power to be brought to bear on crucial aspects of many types of structural comparison and analysis, using visual topological cueing. The invention contains visual methods for enhancing an analyst's ability to identify and robustly recognize relationships between molecular structures and the properties they give rise to.

### CROSS-REFERENCE TO RELATED APPLICATIONS

This application claims priority of U.S. Provisional Patent Application No. 60/583,180, filed Jun. 26, 2004.

### FIELD OF THE INVENTION

This invention relates to a system and methods for selecting objects based on properties, visualizing molecules and visualizing relationships between molecules and properties.

### PRIOR ART

Current systems exist which allow molecular structures to be displayed in 2 or 3 dimensions, showing atoms, bonds, and various surface or volume mapped functions. Current systems exist which allow atoms to be rendered in different colors, depending upon atom type. Highlighting by atom type is not very informative, as there are too many atom types to allow the early visual system to process these in the preattentive visual processing. Furthermore, highlighting by atom type disregards the more fundamental feature of topology type. Where no highlighting is done at all, it is much more difficult to grasp the nature of the molecular structure, and so more difficult to perceive complex relationships between multiple structures, and between multiple structures and their attendant properties.

Current systems exist which allow molecular displays to be spatially ordered by a property value. The problem with this is that adjacent molecules in the display may be separated by an insignificant difference in property value, which is potentially misleading. Additionally, differences between adjacent molecules may be either very small, or very large, with no visual distinctions between these two very different situations—again, potentially misleading.

Current systems allow an analyst to select objects using checkboxes in tabular displays or interacting with plots. Other systems exist which allow algorithmic selection and query-based selection. Other systems exist which allow boolean combination of sets. Other systems exist which allow aggregation of multiple decision criteria into a single one. No systems exist which combine all of these methods and their attendant advantages. No systems exist which allow sorting by selection state. Without being able to sort the objects by selection state, it is currently difficult to determine what has actually been selected so far for interactive review and override.

Current systems exist which allow Multicriterion Decision Making (MCDM). The principle problem facing employing MCDM in practice has to do with the ability to easily capture the domain expert knowledge of the mapping between an attribute, and its' utility (i.e., value, goodness, etc). The best system to date for doing this begins with a line, and asks the analyst to add as many breakpoints as are necessary, and then to set those with parameters. That method insufficiently limits the possibilities and gives no guidance as to how to proceed.

### OBJECTS AND ADVANTAGES

Highlighting by topology (ring or chain) allows structure perception to be accomplished by lower level cognitive systems, freeing up processing power of higher level systems in the brain. It focuses at the level of the most fundamental structural feature (topology), and requires just two colors, making preattentive processing efficient.

One dimensional SAR spectra, which effectively bin the property axis and show molecular structures with each bin, allow ready visualization of the full range of structure-properties behavior, and much more consistent intervals between objects. Looking along a single bin allows chance correlations to be readily recognized and discarded. This greatly improves perception of structure properties relationships for a single property.

Two dimensional SAR spectra, which effectively bin the the two property axes and show molecular structures within each joint bin, allow simultaneous visualization of two structure-property relationships, allowing more complex relations to be recognized. Additionally, they offer ready visualization of the full range of structure-properties behavior, and much more consistent intervals between objects.

Combination of object checkboxes for arbitrary user selection, together with interactive plot selections, query based selections, algorithmic selections, logic operators for combining selections and sorting by selection state value provide a complete system for selecting interesting from uninteresting objects, as well as good from bad. Sorting by selection state, which is unique as an atomic element of the suite, enables gathering the selected items for review and pruning.

Use of a small, visually displayed library of transform functions, coupled with parameterization greatly improves the tractability of capturing expert user knowledge. It also allows key phrases to be displayed alongside each pictorial representation of a function type, to further facilitate this process.

### SUMMARY

The invention provides a system for analyzing either numerical data alone, molecular structure data alone, or combinations of molecular structure and numerical data. It allows molecular structure content to be readily perceived in the dataset and compared between multiple sets. It allows relationships between molecular structures and their correlation with numerical properties to be readily perceived. It allows interesting objects to be quickly identified, and separated from a larger set. It allows ready identification and capture of user knowledge regarding the mapping between attribute value and desirability or utility of these values. It allows overall desirability of objects to be efficiently determined using these user defined rules and for the best objects to be quickly identified through the associated ranking, as well as set aside to constitute the results of a decision process. It allows the user to interact with and override any algorithmic, query, or plot based selections.

In the preferred embodiment of the invention, it allows input of data from either electronic data files, electronic relational databases, or concomitantly running computer processes.

In the preferred embodiment, the invention allows utility transforms and utility aggregation rules to be saved in either electronic file(s) or a relational database. That will allow knowledge to be reused between sessions, as well as shared between users.

In the preferred embodiment of the invention, facilities for handling textual, image and date attributes are also provided.

In the preferred embodiment of the invention, “wizards” are provided to simplify the user definition of utility transforms and aggregates. The term wizards refers to a graphical user interface (GUI) device, whereby multiple input screens are layered in the own window to break up user input into a sequence of discrete steps, with buttons to allow navigation forward or backward in the sequence.

### DRAWINGS

1. Basic System Architecture: shows coarse view of major system components, including interactions with customer resources

2. Maintenance, Display, Alteration of Selection State: shows how selection state is associated with the dataset, and categories of methods for displaying and altering selection state

3. Main Program View: Selection State: Shows main program window with tabular display of a dataset, selection attribute and checkbox interactions, buttons for facile access to algorithmic and graphical alteration of selection state, and facile access to derived utility tables

4. Create Utility Function Wizard (Sample Screens): Shows two screens from the wizard for creating attribute utility functions

5. Main Program View: Utility Table: Shows main program window with the utility table derived from a dataset, column sorting, utility cell visualization by coloring, and colorscale “legend” to describe mapping from cell value to cell color

6. Main Program View: Utility Table (Identifying Problems for a Given Object): Shows main program window with the utility table derived from a dataset, row sorting to rapidly identify problems with a particular object

7. Topological Cueing of Molecular Structures Using Highlighting I: Shows an example of multiple Kekule' structures drawn for molecules, with ring/chain feature highlighting using colors

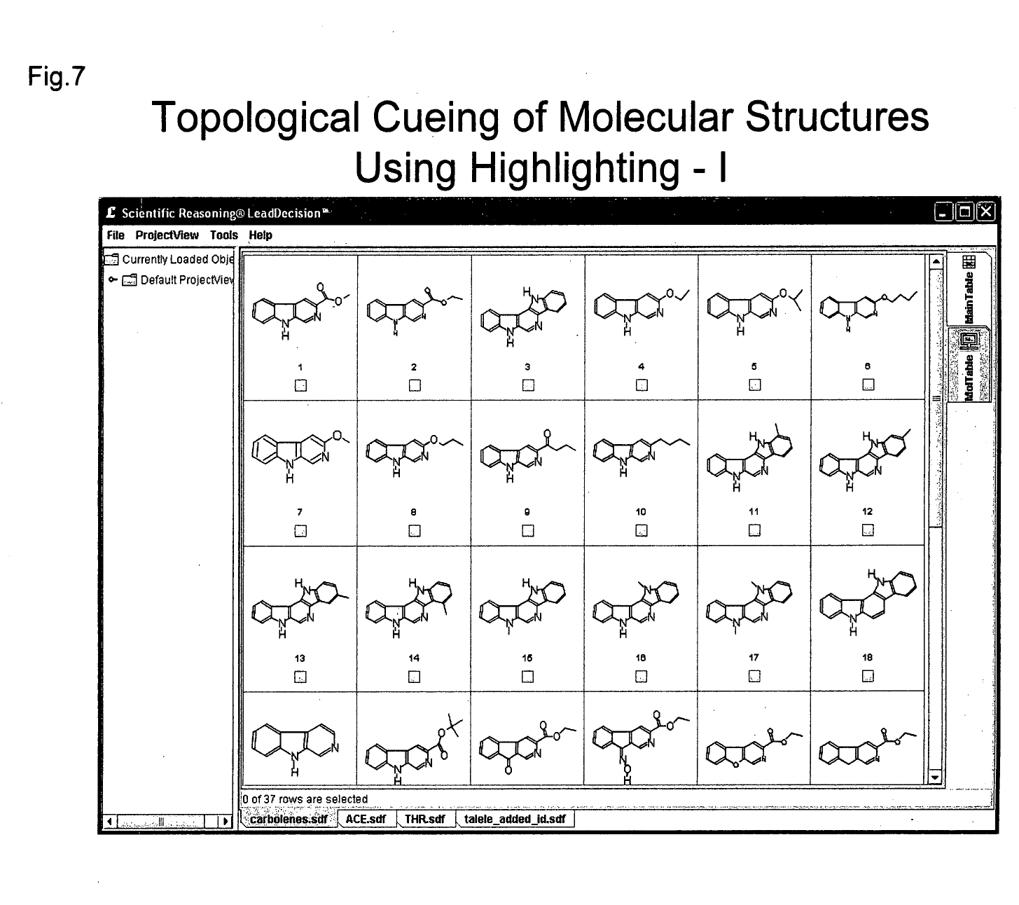

8. Topological Cueing of Molecular Structures Using Highlighting II: Shows the same set of structures as FIG. 7, but without visual topological cueing.

9. 1D SAR Spectrum Plot

10. 2D SAR Spectrum Plot

### DETAILED DESCRIPTION

The invention is suitable for analysis of data of any origin. Data sets are consist of objects, described by attributes. Data objects may correspond to any number of things, for example molecules, proteins, nucleic acids, projects, project plans for the same goal, investments, job/promotion/bonus/award candidates, clients, etc. Attributes correspond to properties of the objects, and may also be of virtually infinite variety, including but not limited to costs, revenues, qualifications, experimental measurements, computed properties, heuristic (semiquantitative) quality values, etc.

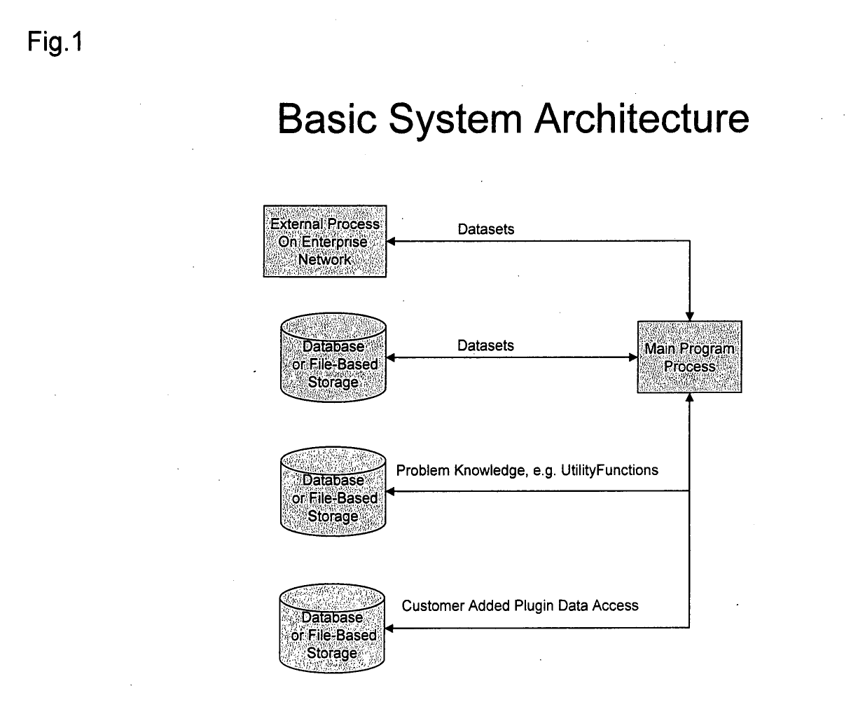

As shown in FIG. 1, data sets may be loaded into the system from computer files, databases, or concomitantly running processes on an intranet or the internet. Similarly modified datasets may be saved back to the corresponding source forms. The system is not dependent on any particular data source or sink type, and, in the preferred embodiment, has as much flexibility as possible for these types of interface to give maximum utility to the user.

User knowledge may be captured with the system, corresponding principally to utility transforms, utility aggregating functions, other numerical transforms, and queries. These may be saved back to permanent storage in the form of a file or database. An alternative interface for this knowledge would again be a concomitantly running process. In this way, knowledge may be saved between sessions and reused, and shared between users. This information flow is also sketched in FIG. 1.

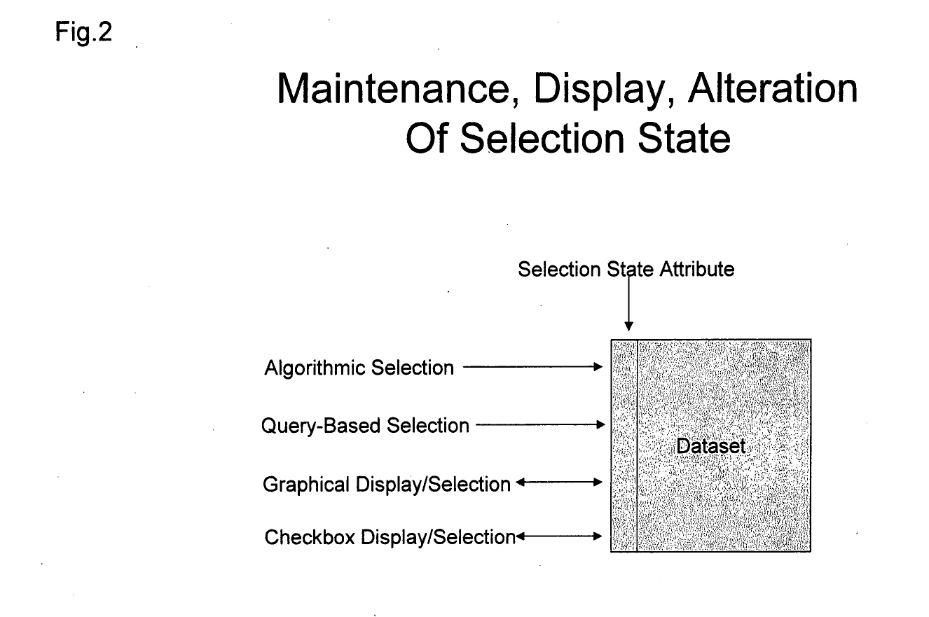

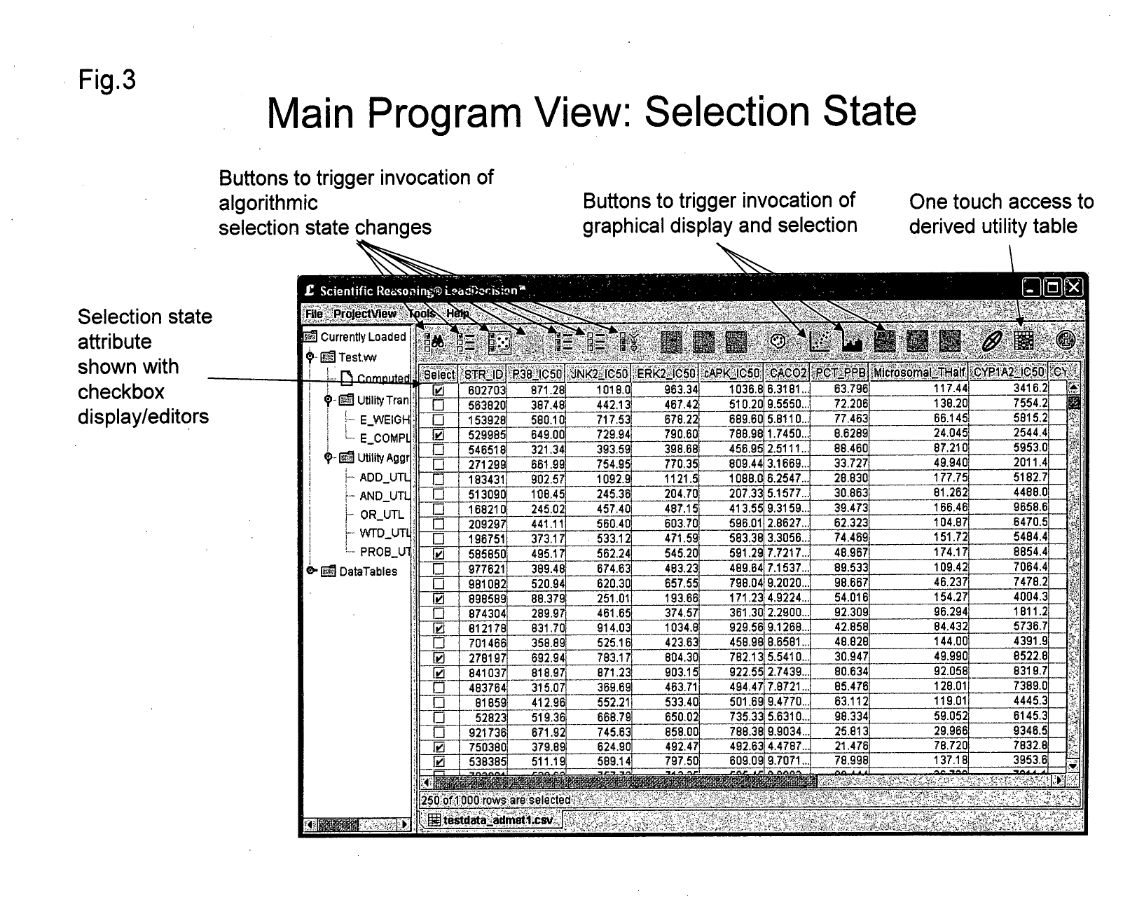

A principal goal for the system is to facilitate selection of a subset of objects from a larger set. This subset may simply be interesting in some way, such as that it unusual, or corresponds to a known interesting set. More importantly, this subset may be the “optimal” subset chosen from the larger set, optimal in the sense of highest value (or utility) objects. To that end, facilities are provided for doing arbitrary interactive, plot interactive, query based, or algorithm based selection. All of these methods operate on a selection state attribute that is automatically added as an attribute to each dataset in the system. Successive selection steps may be combined with SET/AND/OR boolean operators. Also important is the definition of a sorting function on the boolean selection state attribute value in the tabular displays. This enables collecting all the objects which are currently selected for review with just a single click on the selection state column. Following this, the analyst may, for example elect to unselect certain objects which they deem unworthy or uninteresting. The capabilities are illustrated schematically in FIG. 2. The main program screen of an actual embodiment of the invention is show in FIG. 3, which indicates how the different selection methods may be accessed from the main program screen.

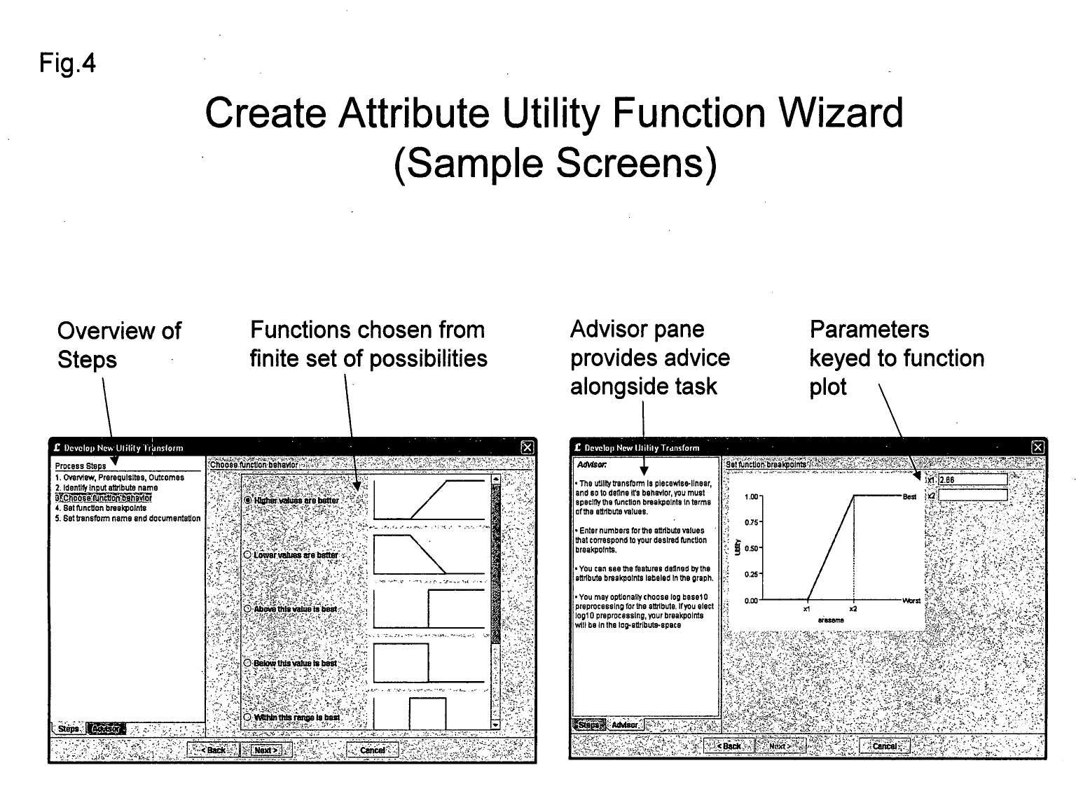

The system also contains special purpose methods to facilitate the identification and capture of utility functions from a domain expert user who is “training” the system, that is, adding to its' knowledge base. This is done using GUI “wizards” to break each process down into a sequence of simple steps. In defining utility functions, the user is in one step shown a visual library of piecewise linear functions to select from, one of which must correspond to their raw attribute to utility attribute mapping rule. In this way instead of beginning with nothing, and asking the expert to produce de novo the functional form (intractable), the process is reduced to two, simple steps. The first is selection of the functional form from among a small number of possibilities. Each of the forms is shown graphically, along with a compact phrase describing it's behavior, e.g., “Above this threshold is good enough”, further aiding identification. Once the functional form is chosen, it is a simple matter to choose the parameters that will then completely define the function. The piecewise linear nature is particularly helpful, because breakpoints can be readily associated with known boundary conditions for the attribute. This knowledge identification and capture ability is crucial, as Multicriterion Decision Making methods have been known for approximately one hundred years as of this writing, but have rarely been employed in practice, principally due to the difficulty of identifying and capturing expert knowledge. An example of choosing the utility transform form and it's parameters is shown in the two wizard screens captured in FIG. 4. A similar wizard is provided for identifying and capturing utility aggregation functions. A utility transform maps from a single raw attribute value to corresponding goodness. A utility aggregating function combines multiple utility values to an overall goodness measure for an object. This summary is needed to determine what is “overall best”.

Attribute and aggregate utility values may be computed automatically and added to the dataset as augmenting columns. They may be visually presented alongside the other attributes, or, separated into a special utility table display.

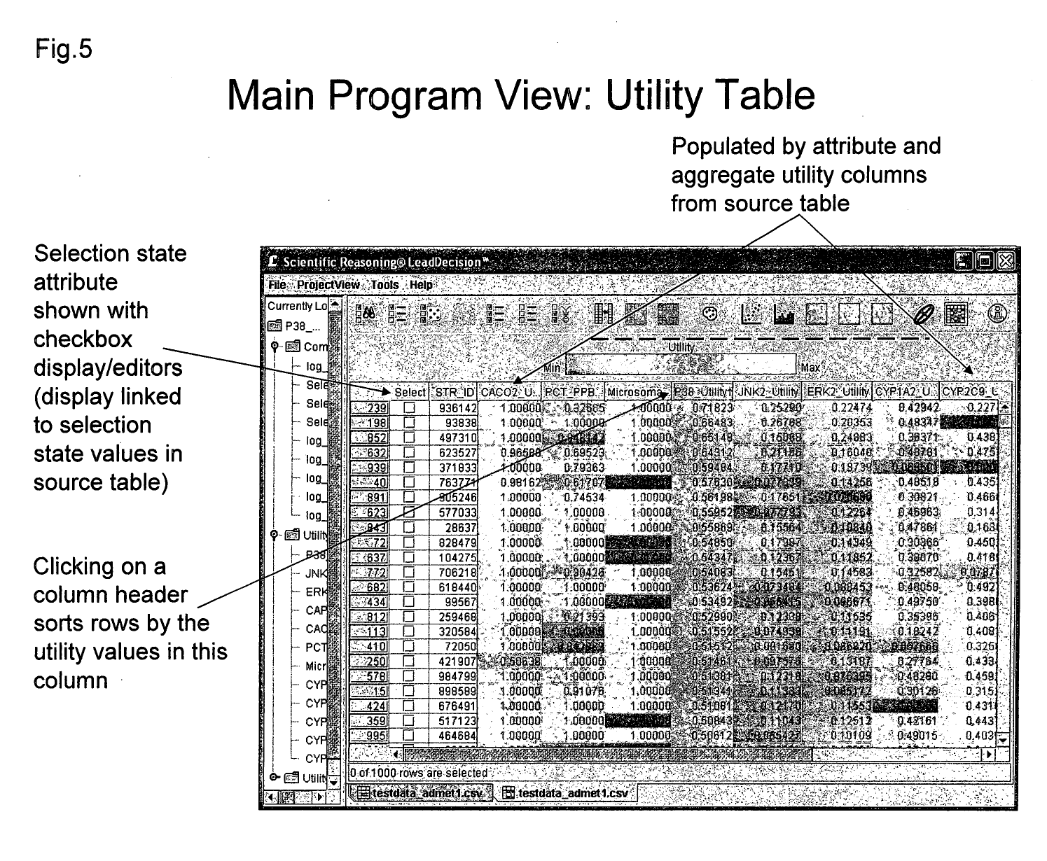

Once present, they may also be colored by value (FIG. 5). While any numbers may be colored by value, the critical aspect of coloring utility numbers by value is that they all correspond to the same concept and scale. In this way, a complex jumble of numbers may be rapidly scanned visually for good or bad objects -just look across the row at the color values. Within a row, problems may be instantly identified by their color value, which may be perceived more rapidly that reading the text of a number. Again, the important thing here is that the colors now have uniform meaning, which is what makes them truly useful.

Sorting by utility value along any given attribute utility allows the analyst to quickly surface what objects are good/bad along this particular attribute (not in general possible for the raw attributes). Sorting along an aggregate utility column allows the analyst to quickly identify which objects are best/worst in totality.

Further, once the utility values are present, they may be plotted, using e.g., histograms to instantly assess set utility distributions along individual or aggregate utilities—answering questions like “How good/bad is this set?” “Where are the problem issues for this set?”. Overlay of such histograms allows set utilities to be compared, allowing the analyst to instantly answer questions like “How do these sets compare in quality?”, “Which set is better in total/this quality?”. Two dimensional scatterplots of utility values allow the analyst to look for correlations—if two utility attributes are highly correlated, the analyst then knows that it is not possible to optimize one of those attributes independently of the other. Data sets may be ranked by sorting or filtered by query, algorithm or graphically based on utility values.

These capabilities to identify and capture utility transforms and aggregates, readily compute them, display them, color them, analyze them, compare them, query them, filter them, rank them are a very fundamental set of capabilities to have in any system for analyzing data. They together bring true meaning to the often used term “Decision Support”.

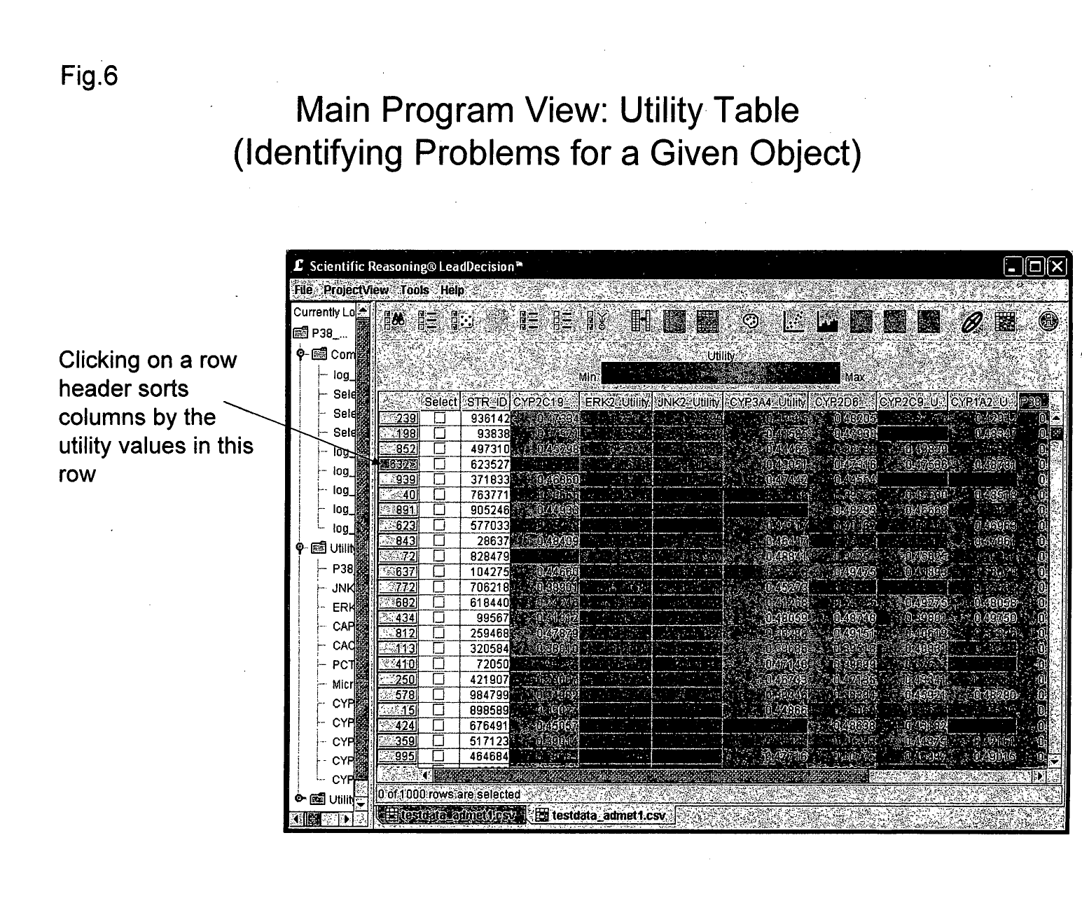

Another helpful feature of the practical embodiment of the invention which has been built is the ability to mouse-click on special row headers in utility tables. The result is that the columns are sorted by the values in the row. When more attribute or aggregate utilities exist than can be seen at one time, this allows the user to quickly identify problems by clicking on the row header for the object to be probed, and bringing the problem columns into view immediately. This is shown in FIG. 6.

For data sets which contain chemical structures as attributes, a fundamental and nontrivial task for the analyst is to simply appreciate the structural content of a molecule or a set of molecules. This is also needed as an atomic task when comparing to sets of structures to see how they differ, looking for structural features in common/difference within a data set, and performing structure properties analysis (sometimes called by the name, structure activity relationship analysis, or SAR).

While a lot remains to be learned, the human brain, visual processing and cognition have been studied for some time, and much is already known. The brain is hierarchically organized with regard to how it carries out processing. There exists a subset of the pattern recognition system called the “early vision system” whose action is often called “preattentive processing”. This goes on at a level below that of conscious thought. See “Information Visualization: Perception for Design, Colin Ware, Elsevier, 2004”. It is highly desirable to transform a visual pattern analysis problem to move as much of the task as possible into the domain of the early vision system. In this way, the finite “bandwidth” or processing power of the conscious thought is made maximally available for the remainder, which therefore allows the analyst to work on problems of maximal complexity.

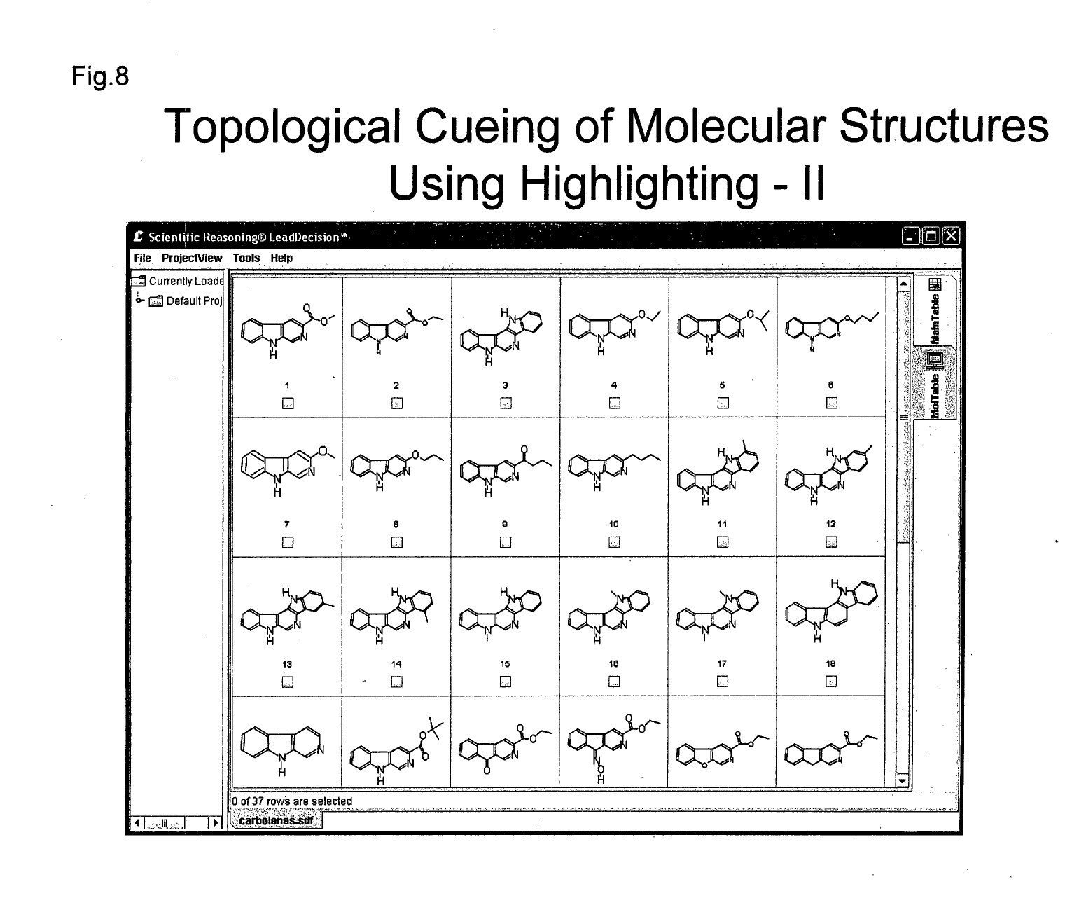

The invention includes a very simple and yet very powerful method for accomplishing the transfer of significant conscious processing into the domain of preattentive processing. What is done is that molecular bonds are divided into two topological categories—ring bonds and chain bonds. Bonds of each category are given a different color. Two-coloring maximizes the ability of the early vision system to segment the image of the molecule into high level structural components. Moreover, topology is the fundamental aspect of molecular structure. This is the reason for example that computational methods for predicting molecular properties (QSPR) perform so well, even when using only topological information. So the invention chooses the most important aspect of the molecular structure, and renders it in such a way as to allow this aspect to be subconsciously processed at high speed. An example of display of a set of structures, with and without topological highlighting, is show in FIGS. 7 and 8.

As has been mentioned earlier understanding correlations between molecular structures and resulting molecular properties is a fundamental task in chemistry, both for academic reasons and for insight into design of materials and their function. Normally, what is done is that a sample of a set of molecules is obtained and their experimental property of interest is determined for each in the lab. If a useful variety of structures was tested, there will be significant variation in the property values. Along with this, there are many types of structure variation occurring, some of which are related to the observed change in properties, and some of which are irrelevant to it. The task of SAR (Structure Activity Relationship) analysis is to determine which aspects of all the structural variation are actually causing the observed differences in property values.

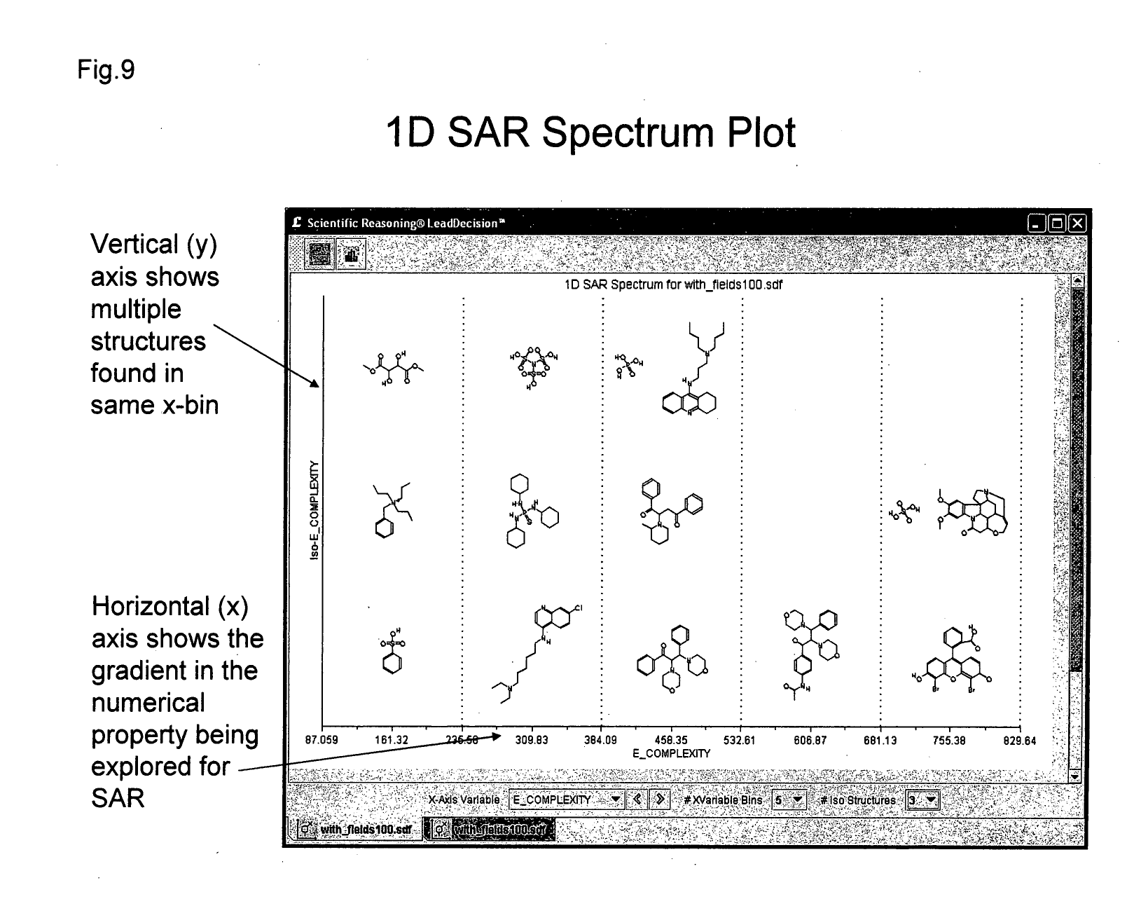

Existing software allows a “SAR table” to be visualized as a tabular display, where one column contains the molecular structures, and another the corresponding properties. A mouse-click gesture allows ordering of the structures by property value, so that a sequence is obtained. Some weaknesses of this are that only a small window of the total variation may be seen at one time, adjacent structures may be separated by property differences within the margin of experimental error, and the amount of the property difference between adjacent structures can vary arbitrarily. The invention contains two related methods for addressing these weaknesses. Consider the 1-Dimensional SAR Spectrum shown in FIG. 9. The horizontal axis is a property axis. The entire range of variation in property value and corresponding structure variation may be seen at once, aiding understanding. The property axis is divided into an integral number of bins, similar to the process used in generating a histogram. Running up the vertical axis are displayed the structures of molecules whose property values lie within the bin. Objects closest to the center of the bin are preferentially selected to try to optimally equalized differences between columns. When looking across the plot horizontally, the analyst can see the spectrum of structural variation causing the observed spectrum of property variation. When looking along a particular vertical column, the analyst can see multiple structures with similar property values, allowing them to reject structure variation modes which are coincidental from the set of possible SAR hypotheses. Options allow the user to select the number of bins, as well as the number of structures shown within each bin.

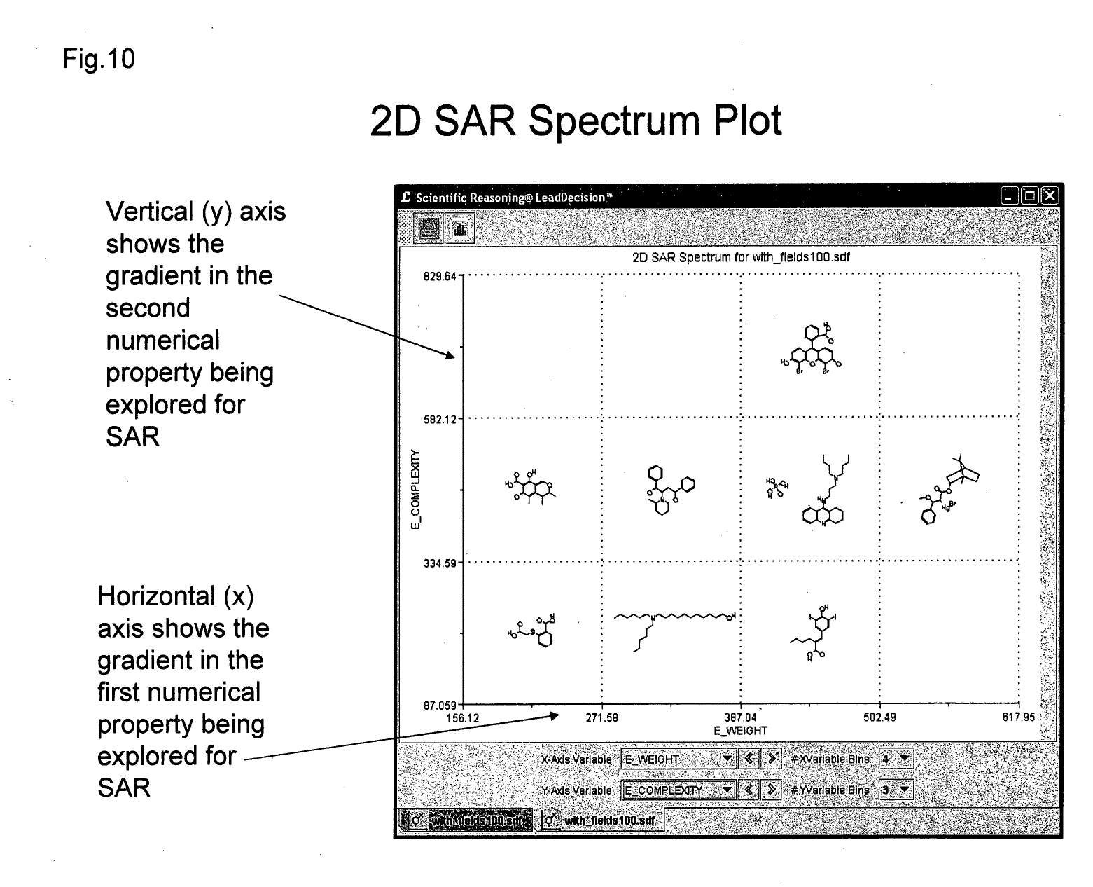

Consider the 2-Dimensional SAR Spectrum shown in FIG. 10. Both the horizontal and the vertical axes are property axes. The entire range of variation in property value and corresponding structure variation may be seen at once, aiding understanding. The property axes are divided into an integral number of bins, similar to the process used in generating a 2-D histogram. Looking at any particular square shows the structures of molecules whose property values lie within the 2-D bin. Objects closest to the center of the 2-D bin are preferentially selected to try to optimally equalized differences between columns. In this way, it is hoped that a new, more complex form of SAR analysis may be realized—two dimensional SAR analysis. Options allow the user to select the number of bins along each property axis.

I claim:

1. A method for visualizing molecules which employs highlighting according to the topological character of the bonds—one color for chain bonds, one color for ring bonds, whereby an analyst may more readily perceive and compare structural features.

2. A method for visualizing relationships between molecular structures and properties which employs one axis for the property and another axis for the molecular structures which fall within a subrange of those properties, whereby an analyst may more readily and robustly perceive structure-properties relationships.

3. A method for visualizing relationships between molecular structures and properties which employs two axes for properties and renders molecular structures which fall within a joint subrange of those two properties, where an analyst may perceive two-dimensional structure-properties relationships.

4. A system for choosing subsets of objects, which employs a column of checkboxes in a tabular display of the objects, along with algorithmic, query based and plot-base filtering tied to checkbox state values. Successive selection steps may be combined with boolean operators. A mechanism for sorting by selection state completes the selection suite, whereby an analyst may isolate an interesting subset of objects from a larger set, including, but not limited to, the best subset.

5. A method for allowing identification and definition of utility transform functions which employs a finite predefined library of piecewise linear functions to visually choose from, and then allows the user to adjust the parameters defining the breakpoints, whereby an analyst may more readily identify and embody expert knowledge regarding an attribute's mapping to utility.

6. A system as described in claim 4, employed so as to select interesting molecules from a candidate set.

7. A method as described in claim 5, employed so as to rank candidates for new materials discovery and development (for example drug discovery and development), and allow selection of the most promising molecules from a larger set of candidates.
